(19) United States
(12) Patent Application Publication
(10) Pub. No.: US 2005/0140591 A1
(43) Pub. Date: Jun. 30, 2005

(54) Plasma display apparatus

(76) Inventors: Antonius Hendricus Maria Holtslag, Eindhoven (NL); Markus Heinrich Klein, Heerlen (NL); Derk Andre Kort, Eindhoven (NL); Fransiscus Jacobus Vossen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/510,253

(22) PCT Filed: Mar. 19, 2003
(86) PCT No.: PCT/IB03/01028

(30) Foreign Application Priority Data
Apr. 9, 2002 (EP) 02076387.6

(51) Int. Cl. G09G 3/28

(52) U.S. Cl. 345/69

(57) ABSTRACT

A plasma display apparatus comprises a waveform generator (WG) coupled between first and the second electrodes (SEl, CEl) to supply, across plasma cells (PCij), a sustain voltage (VCP) with slopes comprising a main part (MA) and a minor part (MI) succeeding the main part (MA). The main part has a duration longer than a formative time 5 lag (FTL) of the plasma cells (PCij), and the minor part has a smaller amplitude than the main part (MA). The plasma cells (pCij) are ignited and sustained by the minor part (MI). The main part (MA) has less steep slopes than the prior-art waveform. Consequently, the EMI produced by the main part (MA) will be at a lower frequency. The minor part (MI) has an amplitude which is relatively low and thus does not add considerably to the EMI, even 10 when its slopes are relatively steep. As the plasma is neither ignited nor sustained by the main part (MA), the main part (MA) further has a lower amplitude than the slope of the prior art and thus produces less EMI.

During the sustain phase of a plasma panel with a matrix of plasma cells, a driver has to supply alternating voltages between electrodes of the plasma panel to generate light in the plasma cells primed to do so. In principle, it is possible to drive the plasma panel with square-wave voltages. However, a large charge or discharge current will flow when the voltage across the capacitance reverses polarity. These large currents are caused by the large plasma panel capacitance present between the electrodes and the steep slopes of the alternating square-wave voltage.

As disclosed in EP-A-0548051 or EP-A-0704834, the driver comprises an energy recovery circuit in which an inductance forms a resonant circuit with the capacitance to lower the power dissipation and the amount of EMI (Electro Magnetic Interference) during the polarity reversal. In the resonant circuit, the voltage across the capacitance reverses resonantly during the polarity reversal, and both the voltage across the capacitance and the current flowing in the capacitance show sine-wavelike waveforms. However, still a considerable amount of EMI is generated as the time available for the resonant polarity reversal is quite short.

Generally speaking, the energy recovery circuit starts a resonance period by decoupling the capacitance from the power supply and coupling the capacitance to the inductance such that the resonant circuit is formed. The resonant circuit causes the resonant polarity reversal to occur. After the resonant polarity reversal, the capacitance is connected to the power supply source in the correct polarity to allow the plasma current of ignited plasma cells to be supplied via the power supply source.

When a pulse of sufficient amplitude is supplied to a plasma cell, the cell will ignite if primed (if the correct amount of charge is present in the cell) to do so. However, it takes some time between the instant when the slope of the pulse occurs and the instant when the ignition of the plasma follows. This delay time is called the formative time lag. This means that from the start of the resonance period, the plasma current will start flowing after the formative time lag. The capacitance must thus be connected to the power supply source before the plasma current starts to flow. Consequently, the resonance period must be shorter than the duration of the formative time lag.

It is an object of the invention to provide a plasma display apparatus with an improved EMI behavior.

To this end, an aspect of the invention provides a plasma display apparatus comprising a plasma display panel with first and second electrodes associated with plasma cells, and a waveform generator coupled between the first and the second electrodes for supplying across the plasma cells a sustain voltage with slopes comprising a main part and a minor part succeeding the main part, the main part having a duration longer than a formative time lag of the plasma cells, and the minor part having a smaller amplitude than the main part, wherein the plasma cells are ignited and sustained by the minor part.

The main part has less steep slopes (the slopes have a duration longer than the formative time lag) than the prior art waveform. Consequently, the EMI produced by the main part will be at a lower frequency, which is an advantage. The minor part has an amplitude which is relatively low and thus does not add considerably to the EMI, even when its slopes are relatively steep. The plasma is ignited and sustained by the slope of the minor part (when added to the main part, the total amplitude is high enough to ignite and sustain the plasma). As the plasma is neither ignited nor sustained by the main part, the main part further has a lower amplitude and a less steep slope than the waveform of the prior art and thus produces less EMI.

U.S. Pat. No. 3,618,071 discloses a sustain waveform which is a superposition of a continuous sine-wave voltage and a pulse voltage. The pulse voltage starts or stops an ignition of the plasma cells but does not sustain the plasma cells. The sine-wave voltage sustains the plasma cells ignited by the pulse voltage. The sustaining of the plasma cells by the sine-wave voltage has the drawback that the sustaining occurs with relatively slow slopes, which causes a lower and less reproducible light output of the plasma cells. An additional difference with the invention is that the amplitude of the prior art sine-wave voltage has to be selected larger than in the present invention because the sine-wave should be able to sustain the plasma cells. In the plasma display apparatus according to the invention, the minor part (comparable with the pulse voltage of the prior art) has to sustain the plasma cells. Thus, the amplitude and value of the main part (comparable with the sine-wave voltage) is selected not to sustain the plasma cells.

In an embodiment as defined in claim 2, the main part is sine-wave shaped to further lower the amount of EMI produced.

In an embodiment as defined in claim 3, the main part comprises substantially one quarter of a sine-wave period lasting 2 to 5 times the formative time lag. Usually (depending on the physical properties of the plasma panel), the formative time lag is about 0.5 microseconds. The duration of the slopes is selected between 1 to 2.5 microseconds, preferably 1.5 microseconds. Consequently, the frequency of the first harmonic drops by a factor of 2 to 5 with respect to the prior art. Also the amplitude drops, for example from 170 volts to 140 volts, which lowers the harmonic power by a factor of (140/170)\hat{ }2=0.68.

In an embodiment as defined in claim 4, the main part forms a substantially continuous sine wave. By using a continuous sine wave, the amount of higher harmonics is minimized.

In an embodiment as defined in claim 5, the substantially continuous sine wave has a period time which is 2 to 20 times longer than the formative time lag. In a plasma panel with a formative time lag of about 0.5 microseconds, the sine wave has preferably a frequency of between 100 and 300 kilohertz.

In an embodiment as defined in claim 6, the waveform generator comprises a first waveform generator for generating an alternating voltage having slopes comprising the main part, a second waveform generator for generating a pulse voltage having slopes comprising the minor part, and a combining circuit for algebraically adding the alternating voltage and the pulse voltage to supply the sustain voltage. Although it is possible to use a driver which generates the combined waveform, it is advantageous to use the separate waveform generators, because this allows the use of present circuits as much as possible.

In an embodiment as defined in claim 7, the first waveform generator comprises an energy recovery circuit having switches and an inductance to form a resonant circuit with a panel capacitance of the plasma panel during the slopes of the alternating voltage, the inductance having a value to obtain a duration of the slopes longer than the formative time lag. This allows the existing energy recovery circuit to be used. The inductance value has to be increased to obtain the longer lasting slopes (or the lower frequency continuous sine wave).

In an embodiment as defined in claim 8, the energy recovery circuit comprises a timing circuit for controlling the switches to couple the panel capacitance to a supply voltage before a resonance current through the inductance becomes zero. As losses always occur in the resonant circuit at the end of the resonance period, the voltage is somewhat lower than the supply voltage. At the instant when the panel capacitance is connected to the power supply, a small jump occurs in the voltage across the panel capacitance. This jump can be enlarged by closing the switches earlier (before the resonance period has ended). It is possible to select the instant at which the switches close to obtain an amplitude of the sine wave which is not able to ignite or sustain the plasma cells, and an amplitude of the jump, such that it acts as the pulse voltage and is able to ignite and sustain the plasma cells.

In an embodiment as defined in claim 9, the energy recovery circuit comprises a load arranged in parallel with the inductance. This resistance causes extra losses in the resonant circuit to enlarge the jump to the desired value. The resistance of this embodiment may be combined with the embodiment as defined in claim 8.

In an embodiment as defined in claim 10, the inductance is a first winding of a transformer, the second waveform generator is coupled to a second winding of the transformer, and the combining circuit comprises the transformer. By replacing the inductance by the primary winding of the transformer, the existing energy recovery circuit can be used. It is not required to adapt the drive structure of the plasma display. The pulse voltage is added to the alternating voltage generated by the energy recovery circuit via the secondary winding of the transformer.

In an embodiment as defined in claim 11, the first waveform generator comprises a transformer with a first and a second winding. The first winding is arranged in a power supply line of the energy recovery circuit, and the second winding is coupled to the second waveform generator. The combining circuit comprises the transformer. By placing the transformer primary winding in the power supply line, the pulse voltage is added via the secondary winding of the transformer to the alternating voltage generated by the energy recovery circuit. The energy recovery circuit is adapted to generate less steep slopes. The lower amplitude of the alternating voltage is obtained by decreasing the power supply voltage.

In an embodiment as defined in claim 12, the pulse voltage is a substantially rectangular pulse. This has the advantage that the ignition of the plasma cells is caused by the very steep edges of the pulse voltage. When the slopes are not steep enough, the ignition of the plasma cells is not reproducible, nor is the light output optimal. Due to the relatively low amplitude of the pulse voltage, the high frequencies of the steep slopes cause a relatively low contribution to the EMI.

In an embodiment as defined in claim 13, the second waveform generator comprises an energy recovery circuit. Now, the steep edges of the pulse voltage of claim 13 become sine-wave shaped and the EMI is decreased.

The energy recovery circuit comprises an inductor with a value selected to obtain a duration of slopes of the pulse voltage being less than the formative time lag. The duration of the slopes should not be longer than the formative time lag to allow the switches of the energy recovery circuit to connect the panel capacitance to the power supply voltage before the large plasma (sustain) current starts to flow.

These and other aspects of the invention are apparent from and will be elucidated with reference to the embodiments described hereinafter.

In the drawings:

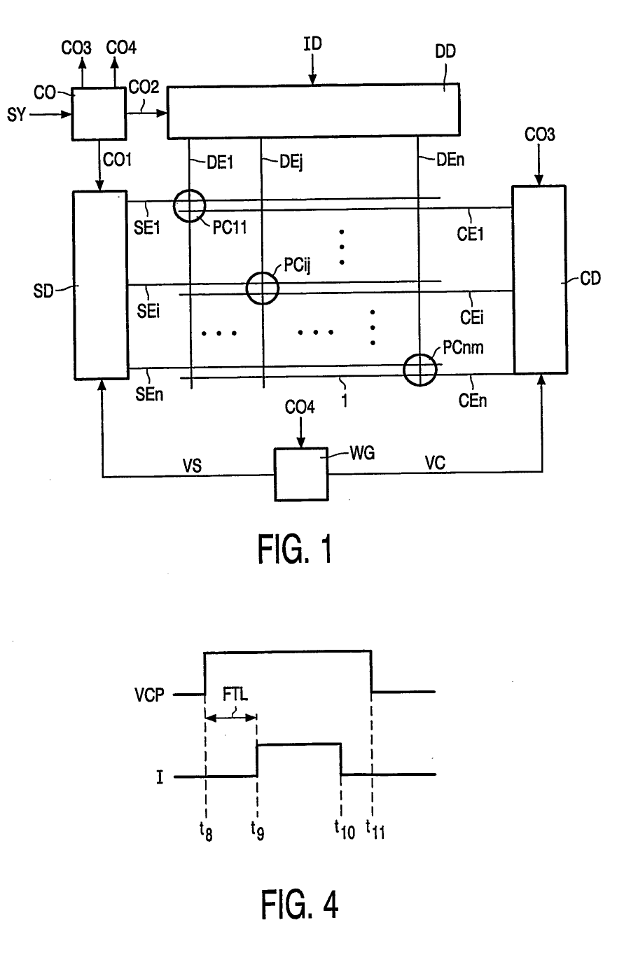

FIG. 1 is a block diagram of a plasma display apparatus,

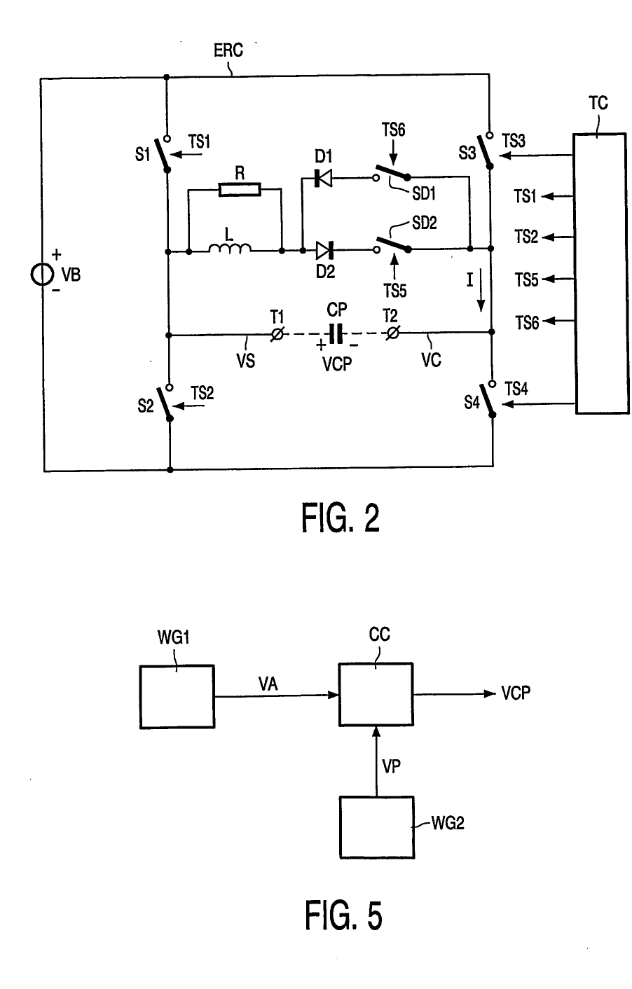

FIG. 2 shows an energy recovery circuit in according to the invention,

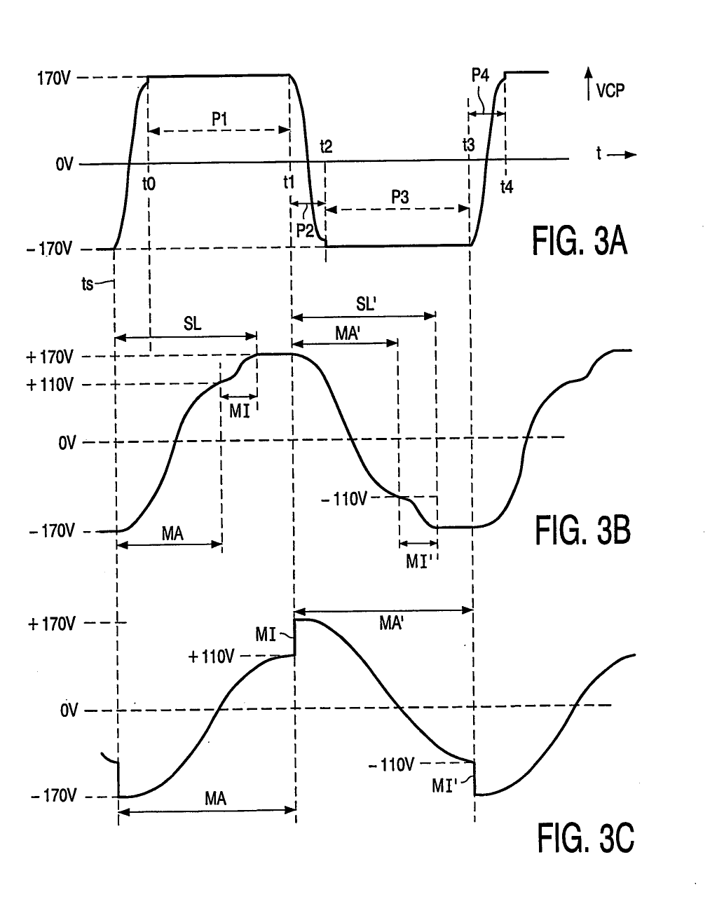

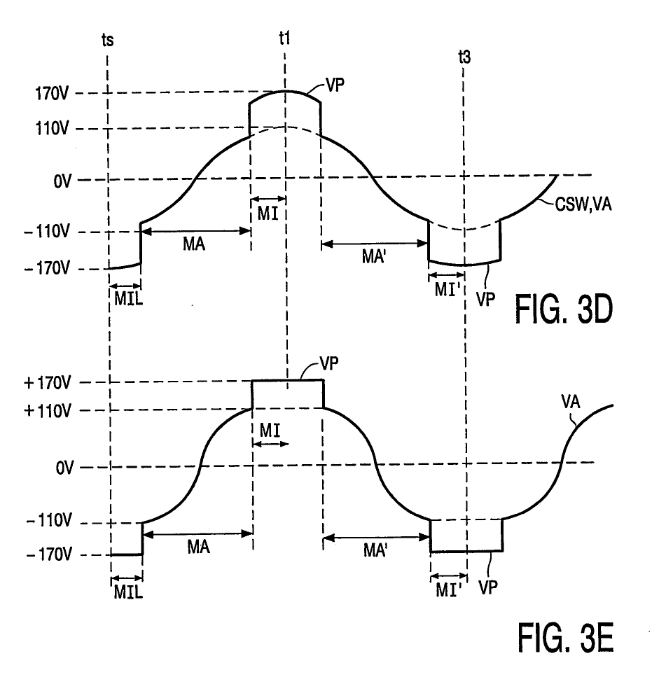

FIG. 3 are waveforms showing a sustain pulse of a plasma display apparatus with an energy recovery circuit, FIG. 3A shows a sustain pulse occurring in the prior art plasma display apparatus, FIGS. 3B to 3E show a sustain pulse as generated in embodiments according to the invention,

FIG. 4 is a timing diagram elucidating the formative time lag,

FIG. 5 shows an embodiment of a driver according to the invention,

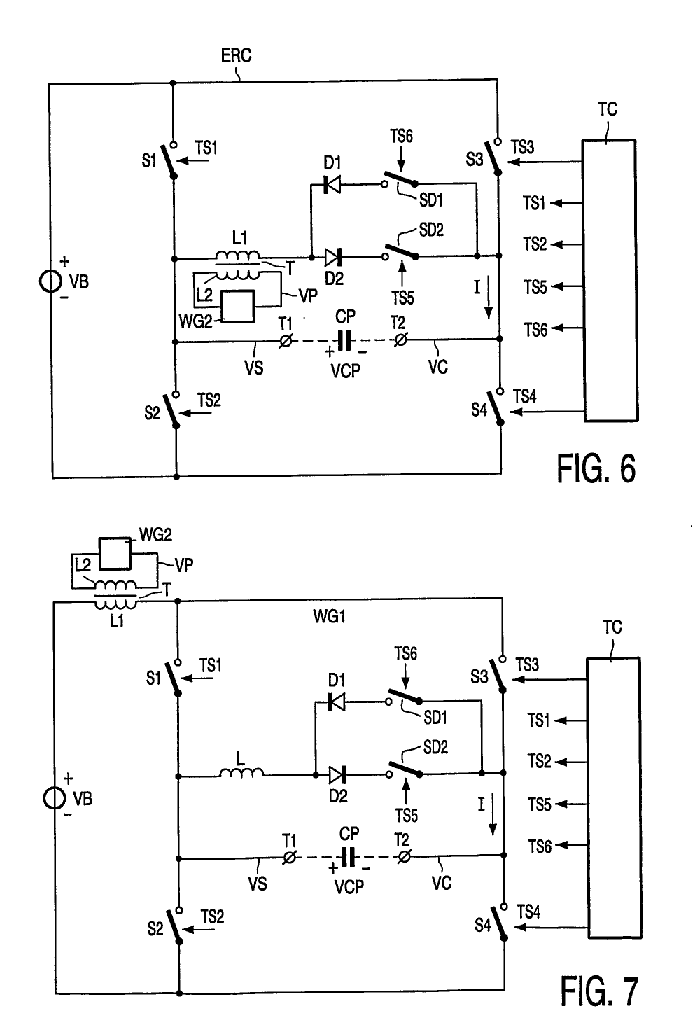

FIG. 6 shows another embodiment of a driver according to the invention, and

FIG. 7 shows still another embodiment of a driver according to the invention.

In different Figures, the same references refer to the same elements performing the same function.

FIG. 1 is a block diagram of a plasma display apparatus.

The plasma display apparatus comprises a plasma display panel 1, a data driver DD, a scan driver SD, a common electrode driver CD, a controller CO, and a waveform generator WG.

The known three-electrode plasma display panel 1 comprises scan electrodes SE1 to SEn, further referred to as SEi, common electrodes CE1 to CEn, further referred to as CEi, data electrodes DE1 to DEm, further referred to as DEj, and plasma cells PC11 to PCnm, further referred to as PCij.

The scan electrodes SEi and the common electrodes CEi are arranged substantially parallel. Neighboring scan electrodes SEi and common electrodes CEi are associated with the same plasma cells PCij. Usually, the plasma cells PCij are not physically separated but are areas in a plasma channel. The plasma channel is associated with the neighboring scan and common electrodes SEi and CEi. The areas forming the plasma cells PCij are associated with the neighboring scan and common electrodes SEi and CEi and a crossing data electrode DEj. The data electrodes DEj are arranged substantially perpendicular with respect to both the scan electrodes SEi and the common electrodes CEi.

The scan driver SD supplies scan voltages to the scan electrodes SEi. The common driver CD supplies a common voltage to the common electrodes CEi. The common driver may supply the same common voltage to all the common electrodes CEi, or to groups of the common electrodes CEi. The data driver DD receives input data ID to supply data voltages to the data electrodes DEj.

A controller CO receives synchronization signals SY belonging to the input data ID to supply a control signal CO1 to the scan driver SD, a control signal CO2 to the data driver DD, a control signal CO3 to the common electrode driver CD, and a control signal CO4 to the driver WG. The controller CO controls the timing of the pulses and the signals supplied by these drivers.

The plasma display apparatus operates in a known manner.

During an addressing period of the plasma display panel 1, the plasma channels are usually ignited one by one. An ignited plasma channel has a low impedance. The data voltages on the data electrodes DEj determine an amount of charge in each plasma cell PCij (the pixels) associated with the data electrodes DEj and the low impedance plasma channel. A pixel PCij preconditioned by this charge to produce light during the sustain period succeeding the addressing period will be lit during this sustain period. A plasma channel which has a low impedance is further referred to as a selected line (of pixels). During the addressing phase, the data signals to be stored in the pixels PCij of a selected line are supplied line by line by the data driver DD.

During the sustain phase, the scan driver SD and the common electrode driver CD supply select pulses and common pulses, respectively, to all the lines comprising the data stored during the preceding addressing period. The pixels pre-charged to be lit will produce light whenever the associated plasma cells PCij are ignited. A plasma cell PCij will be ignited when it is pre-charged to do so and the sustain voltage supplied across the plasma cell PCij by the associated scan electrode SEi and common electrode CEi changes a sufficient amount. The number of ignitions determine the total amount of light produced by a pixel PCij.

In a practical implementation, the sustain voltage comprises pulses of alternating polarity. The voltage difference between the positive and the negative pulses is selected to ignite the plasma cells PCij pre-charged to produce light, and not to ignite the plasma cells PCij pre-charged not to produce light.

The invention is directed to the waveform generator WG which provides a scan voltage VS and a common voltage VC such that a sustain voltage VCP across the plasma cells PCij occurs which has slopes with a main part and a succeeding minor part. The main part has a lower amplitude (should not be able to sustain the plasma) and less steep slopes (longer than the formative time lag) with respect to the waveforms generated by the known energy recovery circuits. The minor part has a relatively low amplitude, it suffices that the minor part which succeeds the main part enlarges the amplitude of the total waveform such that the plasma is ignited in response to the minor part. The minor part may show steep slopes to obtain an optimal ignition of the plasma. The amount of EMI produced by the minor part will be relatively low due to its relatively low amplitude.

It is possible to define the resulting sustain voltage VCP as a superposition of an alternating voltage VA and a pulse voltage VP (examples are indicated in FIGS. 3D and 3E). The slopes of the alternating voltage VA are the main parts MA, and the slopes of the pulse voltage VP are the minor parts MI. The amplitude of the alternating voltage VA is selected not to ignite nor sustain the plasma, and its slopes have a duration which is longer than the formative time lag FTL. Preferably, the amplitude of the alternating voltage VA is as large as possible to obtain an amplitude of the pulse voltage VP which is as low as possible to minimize the EMI caused by the relatively steep slopes of the pulse voltage VP.

The voltage VCP across the plasma cells PCij need not actually be generated as two separate waveforms which are algebraically added. The voltage VCP may be generated as a single waveform having several portions or parts.

During the sustain phase, the voltage across all the plasma cells PCij has to change polarity. All the plasma cells PCij arranged in parallel form the large panel capacitance CP. As discussed earlier with respect to the prior art, the polarity reversal has to take place within the formative time lag of the plasma cells PCij. By way of example, in a practical situation wherein 120 rows of a 42″ panel are connected in parallel, the panel capacitance is 15 nF, and the sustain voltage has to change from −170V to +170V in about 0.5 microseconds causing a current of about 45 Amperes. This large current will cause a large amount of EMI, especially if the sustain voltage has steep slopes, such as the 0.5 microsecond which is required because the panel capacitance has to be connected to the power supply before the sustain current starts to flow. The start of the flow of the sustain current with respect to the start of the sustain slope is the formative time lag FTL.

FIG. 2 shows an energy recovery circuit.

The energy recovery circuit ERC comprises a terminal T1 to supply the scan voltage VS to the scan driver SD, and a terminal T2 to supply the common voltage VC to the common driver CD. The terminal T1 is connected to a negative pole of a power supply source which supplies a power supply voltage VB via an electronic switch S2, and to a positive pole of the power supply source via an electronic switch S1. The terminal T2 is connected to the negative pole of the power supply source via an electronic switch S4, and to the positive pole of the power supply source via an electronic switch S3.

The terminal T1 is connected to the terminal T2 via a series arrangement of a coil L, a diode D2, and an electronic switch SD2. The diode D2 is poled to conduct a current I flowing in the direction of the indicated arrow. A series arrangement of a diode D1 and an electronic switch SD1 is arranged in parallel with the series arrangement of the diode D2 and the switch SD2. The diode D1 is oppositely poled with respect to the diode D2. A timing circuit TC supplies control signals TS1 to TS6 to the switches S1 to S4, and the switches SD2 and SD1, respectively. A resistor R is arranged in parallel with the coil L.

The electronic switches may be any controllable electronic switch such as a bipolar or MOSFET transistor.

The operation of the energy recovery circuit is elucidated with respect to FIG. 3.

FIG. 3 show waveforms of a sustain pulse of a plasma display apparatus with an energy recovery circuit.

FIG. 3A shows a sustain pulse VCP=VS-VC occurring in the prior-art plasma display apparatus. In the prior-art plasma display panel, the resistor R shown in FIG. 2 is not present.

A rising edge of the sustain pulse VCP starts at the instant ts and ends at the instant t1. A sustain cycle is described, starting from the phase P1 (starting at the instant t0 and ending at the instant t1) wherein the switches S1 and S4 are closed and the panel capacitance CP is charged to the power supply voltage VB (which is, for example, 170V).

At the instant t1, the switches S1 and S4 are opened and the switch SD2 is closed. The coil L and the panel capacitance CP form a resonant circuit, a sine-wave current I starts to flow. During this resonance period P2, a cosine-shaped voltage VCP will be present across the panel capacitance CP. At the instant t2, the current I through the panel capacitance CP changes polarity, and the resonant circuit stops resonating because the diode D2 blocks the current I. Now, the switches S2 and S3 should be closed to connect the power supply voltage VB in the negative polarity across the panel capacitance CP. The switch SD2 can be opened.

During the period P3 when the switches S2 and S3 are closed, the large sustain current flowing when the plasma ignites is supplied by the power supply source and an inevitable energy loss in the resonant circuit is compensated (the small step in the voltage VCP at the instant t2). At the instant t3, the switches S2 and S3 are opened and the switch SD1 is closed. Now, during the period P4, the voltage across the panel capacitance CP resonantly changes its polarity again.

This prior art uses a half-period resonance phenomenon to change the polarity of the voltage across the panel capacitance CP. By recovering the energy stored in the panel capacitance CP, smooth slopes (during the periods P2 and P4) are supplied to the plasma panel 1 and the amount of EMI produced is decreased with respect to systems not using an energy recovery circuit. The plasma (associated with cells which are primed to produce light) will be ignited by the resonance slopes during the periods of time P2 and P4.

FIG. 3B shows a sustain pulse generated in an embodiment according to the invention. The differences between this sustain pulse VCP and the prior art sustain pulse shown in FIG. 3A are:
(i) the amplitude of the sine-wave portions is smaller (for example, 280V instead of 340V) such that these sine-wave portions are not able to ignite nor sustain the plasma cells PCij.
(ii) the slope of the sine-wave portions is less steep, this is possible because the sine-wave portions are not relevant for the ignition nor for sustaining the plasma cells PCij, so that the formative time lag FTL is not a limiting factor.
(iii) the step in the sustain pulse at the instant t0 is selected such (for example, 60V) that the plasma will be ignited by this step superposed on the sine-wave portion. The steepness of the slope of this step is relevant as the formative time lag FTL is important now. In FIG. 3B, the slope of this step is generated by a further energy recovery circuit and is thus cosine-shaped and has a duration of 0.5 microsecond shorter than the formative time lag FTL. It is allowed to have a steeper slope of the step, but the gain in EMI then becomes smaller. However, the gain in EMI will still be large due to the small amplitude of the step voltage.

The sine-wave portions are examples of the main part MA or the alternating voltage VA. The step is an example of the minor part MI or the pulse voltage VP. The main parts are indicated by MA for rising slopes and MA′ for falling slopes. The minor parts are indicated by MI for rising slopes and MI′ for falling slopes.

The waveform shown in FIG. 3B may be considered to be the superposition of, on the one hand, a sine-wave shaped voltage VA with a rising slope MA and a falling slope MA′ which are connected by a flat part and, on the other hand, a pulse-shaped voltage VP with a rising slope MI and a falling slope MI′ which are connected by a flat part. Preferably, the rising and falling slopes in both the voltage VA and VP are centered to have equal maximum and minimum values.

This waveform may be generated by the embodiments according to the invention shown in FIG. 6 and FIG. 7. The resistor shown in FIG. 2 is not present.

FIG. 3C shows a sustain pulse generated in an embodiment according to the invention. The differences between this sustain pulse VCP and the sustain pulse shown in FIG. 3B is that the sine-wave portions are selected as long as possible such that the lowest possible frequency of the sine wave is obtained. Also this waveform may be considered to be a superposition of an alternating voltage VA which is a continuous sine-wave voltage and a pulse voltage VP which has an edge (or steep slope) at the instant t1 and an oppositely poled edge at the instant t3.

The sustain pulses VCP shown in FIGS. 3B and 3C can be generated in many ways. For example, the composite waveform is generated by the waveform generator WG which comprises a small signal waveform generator and a class A or D output stage. These sustain pulses are preferably generated by the energy recovery circuit of FIG. 2. This has the advantage that the driving of the plasma panel 1 is adapted minimally with respect to the prior art. The differences with respect to the prior-art energy recovery circuit are that the inductance of the coil is increased (for example, 4 to 25 times) to obtain the longer lasting sine-wave (cosine-shaped) portions. The resistor R is added to obtain losses which cause the sine-wave portions to have smaller amplitudes, such that the plasma will not be ignited and will not be sustained if already ignited. The pulse voltage (the step, which, for example, jumps from 110V to 170V) has the correct value automatically as it is determined by the value (not adapted) of the power supply voltage VB and the value of the resistor. The plasma is ignited by the steps in the pulse voltage VP.

It is also possible to obtain the step in the sustain voltage VCP by closing the switches S1 and S4 before the resonance period P2, P4 has ended. The current I is still flowing in the resonant circuit and the cosine-shaped waveform is not yet at its maximum value. The resistor R may not be required in this situation, obviating the extra losses introduced by the resistor R.

It is also possible to replace the resistor R by a transformer as shown in FIG. 6. The required losses are introduced by a load on the secondary winding of the transformer. The secondary winding of the transformer preferably supplies a power supply voltage for a circuit of the display apparatus. Instead of dissipating the energy in the resistor, it is usefully used.

FIG. 3D shows a sustain pulse VCP generated in an embodiment according to the invention. This sustain pulse VCP is a pulse signal VP which is superposed on a continuous sine-wave waveform CWS, VA. The rising slope of the sustain voltage VCP starts at the instant ts with the pulse VP added to the sine-wave CWS, VA. After the period of time MIL, the pulse ends and the main part MA starts. The pulse VP occurs at the end of the main part MA. This pulse VP lasts the period of time MI until the instant t1 during the rising slope. The plasma is ignited by the pulse VP when it rises at the start of the period of time MI, and when it drops in the period of time MI′ before the instant t3.

FIG. 3E shows a sustain pulse VCP generated in an embodiment according to the invention. This sustain pulse VCP is a pulse signal superposed between a waveform of cosine portions. The dotted lines during the periods when the pulse signal VP is present (around the instants t1 and t3) show the sine-wave shaped alternating voltage VA. As with the slopes shown in FIG. 3D, the slopes comprise successively a pulse part (MIL), a sine-wave shaped part (MA), and again a pulse part (MI′).

Also, the waveforms shown in FIGS. 3D and 3E can be generated in many ways. These waveforms are preferably generated by the circuits shown in and described with respect to FIGS. 5 to 7.

FIG. 4 is a time diagram elucidating the formative time lag. The sustain voltage VCP is shown as a pulse with a rising slope at the instant t8 and a falling slope at the instant t11. For simplicity, the actual shape of the slope is not shown. The plasma current I flowing through the plasma panel 1 when the plasma is ignited starts at the instant t9 which is the formative time lag FTL later than the instant t8 at which the slope of the sustain voltage VCP across the plasma panel 1 occurs. The plasma current I flows until the instant t10. For the sake of simplicity, the plasma current is shown as a rectangular pulse, its actual shape may differ.

FIG. 5 shows an embodiment of a waveform generator according to the invention. The waveform generator WG comprises a waveform generator WG1 which generates the alternating voltage VA and a waveform generator WG2 which generates the pulse voltage VP. The alternating voltage VA comprises the cosine-shaped portions or the continuous sine wave. The pulse voltage VP may comprise rectangular pulses causing the jumps in the sustain voltage VCP.

A combiner CC combines the alternating voltage VA and the pulse voltage VP to obtain the sustain voltage VCP. The combiner CC superposes its input voltages such that these voltages are algebraically added.

FIG. 6 shows another embodiment of a driver according to the invention. In this embodiment, the coil L present in FIG. 2 is replaced by a transformer T with a primary winding L1 and a secondary winding L2. The winding L1 is inserted in FIG. 2 at the position of the deleted coil L. The winding L2 is connected to the waveform generator WG2 to receive the pulse voltage VP which is superposed by the transformer T on the cosine-shaped portions of the voltage generated by the energy recovery circuit ECR which is the waveform generator WG1.

FIG. 7 shows still another embodiment of a driver according to the invention. In this embodiment, a winding L1 of a transformer T is arranged in series with the power supply voltage source. The winding L2 is connected to the waveform generator WG2 to receive the pulse voltage VP which is superposed by the transformer T on the voltage generated by the energy recovery circuit ECR which is the waveform generator WG1.

It should be noted that the above-mentioned embodiments illustrate rather than limit the invention, and that those skilled in the art will be able to design many alternative embodiments without departing from the scope of the appended claims. For example, the invention is applicable to plasma display panels other than the three-electrode panel discussed, such as a two-electrode plasma display panel.

Where the sustain voltage VCP across the panel capacitance CP is shown, this voltage may be supplied either on the scan or common electrode SEi, SCi only. Preferably, a part of this voltage is supplied on the scan electrodes SEi and the other part on the common electrode CEi. For example, the sine-wave portions may be supplied on the common electrode CEi and the pulse signal on the scan electrodes SCi, or the other way around. Preferably, in systems wherein a single common driver CD drives all the common electrodes in parallel (or when a few drivers drive large blocks of interconnected common electrodes) the sine-wave portions are supplied to the common electrode. This decreases the current for charging the large panel capacitor considerably.

It is also possible to supply the same pulses 180 degrees out of phase to the scan and common electrodes SEi, SCi. For example, the scan voltage is 170V while the common voltage is 0V, and the falling slope of the scan voltage VS to 0V coincides with the rising slope of the common voltage VC.

In the claims, any reference signs placed between parentheses shall not be construed as limiting the claim. Use of the verb “comprise” and its conjugations does not exclude the presence of elements or steps other than those stated in a claim. Use of the indefinite article “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A plasma display apparatus comprising:
a plasma display panel with first and second electrodes associated with plasma cells, and
a waveform generator coupled between the first and the second electrodes for supplying, across the plasma cells, a voltage with slopes comprising a main part and a minor part succeeding the main part,
the main part having a duration longer than a formative time lag of the plasma cells, and
the minor part having a smaller amplitude than the main part, wherein the plasma cells are ignited and sustained by the minor part.

2. A plasma display apparatus as claimed in claim 1, characterized in that the waveform generator is adapted to generate the main part which is sine-wave shaped.

3. A plasma display apparatus as claimed in claim 2, characterized in that the waveform generator is adapted to generate the main part which comprises substantially one quarter of a sine-wave period lasting 2 to 5 times the formative time lag.

4. A plasma display apparatus as claimed in claim 1, characterized in that the waveform generator is adapted to generate the main part to form a substantially continuous sine wave.

5. A plasma display apparatus as claimed in claim 4, characterized in that the substantially continuous sine wave has a period time which is 2 to 20 times longer than the formative time lag.

6. A plasma display apparatus as claimed in claim 1, characterized in that the waveform generator comprises:
a first waveform generator for generating an alternating voltage having slopes comprising the main part,
a second waveform generator for generating a pulse voltage having slopes comprising the minor part, and
a combining circuit for algebraically adding the alternating voltage and the pulse voltage to supply the sustain voltage.

7. A plasma display apparatus as claimed in claim 6, characterized in that the first waveform generator comprises an energy recovery circuit having switches and an inductance to form a resonant circuit with a panel capacitance of the plasma panel during the slopes of the alternating voltage, the inductance having a value to obtain a duration of the slopes longer than the formative time lag.

8. A plasma display apparatus as claimed in claim 7, characterized in that the energy recovery circuit comprises a timing circuit for controlling the switches to couple the panel capacitance to a supply voltage before a resonance current through the inductance becomes zero.

9. A plasma display apparatus as claimed in claim 7, characterized in that the energy recovery circuit comprises a load arranged in parallel with the inductance.

10. A plasma display apparatus as claimed in claim 7, characterized in that the inductance is a first winding of a transformer, the second waveform generator is coupled to a second winding of the transformer, and the combining circuit comprises the transformer.

11. A plasma display apparatus as claimed in claim 7, characterized in that the first waveform generator comprises a transformer with a first and a second winding, the first winding being arranged in a power supply line of the energy recovery circuit, the second winding being coupled to the second waveform generator, wherein the combining circuit comprises the transformer.

12. A plasma display apparatus as claimed in claim 6, characterized in that the second waveform generator is adapted to generate a pulse voltage which is a substantially rectangular pulse.

13. A plasma display apparatus as claimed in claim 12, characterized in that the second waveform generator comprises an energy recovery circuit with an inductor with a value selected to obtain a duration of edges of the pulse voltage being less than the formative time lag.
